(19) United States
(12) Patent Application Publication
(10) Pub. No.: US 2009/0238400 A1
(43) Pub. Date: Sep. 24, 2009

(54) Sound generating apparatus embedded into shoe and its shoes

(76) Inventor: Suk Bin Im, Seoul (KR)

Correspondence Address: ABELMAN, FRAYNE & SCHWAB, 666 THIRD AVENUE, 10TH FLOOR, NEW YORK, NY, 10017, US

(21) Appl. No.: 11/920,934

(22) PCT Filed: Mar. 29, 2006
(86) PCT No.: PCT/KR2006/001137

§ 371 Date: Nov. 19, 2007

(30) Foreign Application Priority Data
May 18, 2005 (KR) 10-2005-0041693
Jun. 30, 2005 (KR) 10-2005-0058035

(51) Int. Cl. H04R 1/02; A43B 23/00

(52) U.S. Cl. 381/388; 36/139

(57) ABSTRACT

The present invention relates to a sound generating apparatus embedded into a shoe and its shoes, the sound generating apparatus having a sensor embedded into the shoe to generate simple sounds, numeral voices together with the simple sounds or numeral voices in a multiplication table in a case where consecutive motions are detected a certain number of times within a predetermined time or at a less time interval than the predetermined time.

### TECHNICAL FIELD

The present invention relates to a sound generating apparatus embedded into a shoe and its shoes, the sound generating apparatus having a sensor embedded into the shoe to generate simple sounds, numeral voices together with the simple sounds or numeral voices in a multiplication table in a case where consecutive motions are detected a certain number of times within a predetermined time or at a less time interval than the predetermined time; having a plurality of sensors embedded into the shoe to generate sounds of instruments different from each other or different sounds of identical instruments corresponding to each of the sensors or combinations of the sensors if a motion signal is detected from the sensors so that a beat box or the like can be provided; and having a built-in motion recognition microchip embedded into the shoe to generate simple sounds, numeral voices together with simple sounds, numeral voices in a multiplication table or sounds of instruments corresponding to a certain motion if the certain motion is detected.

### BACKGROUND ART

In general, shoes are mainly classified into dress shoes of which appearance is considered to be important and sport shoes, sandals or slippers, of which function is considered to be important. Further, the shoe comprises an upper for covering a top of a foot and a sole for forming a bottom of the shoe to be contacted with the sole of the foot. In particular, the sole comprises an outsole which is contacted directly with the ground so that its functions of impact absorption, abrasion resistance, slip prevention and the like are required, and an insole which is contacted with the foot of a human body.

Since conventional shoes are generally intended to enable people to simply wear and move, they have been manufactured with a simple object of protection and convenience of feet.

However, in order to achieve sales promotion by inducing customers to buy products, shoes from which a sound or the like can be generated to excite their interest have been also developed.

Since the sounding shoes are provided with sounding means having a vibrating plate in an outsole of the shoe so that a sound is generated whenever kids move their steps, thereby arousing their interest and helping them with sense training and walking practice, the sounding shoes have been widely used.

### DISCLOSURE OF INVENTION

### Technical Problem

Meanwhile, in the aforementioned sounding shoe, since a microchip, switch or the like are embedded into an outsole portion to generate sounds when a foot of a wearer reaches the ground so that the sounds are generated whenever the wearer moves, there is a disadvantage in that the wearer easily feels bored, and much power is consumed to use the shoe.

### Technical Solution

The present invention is conceived to solve the aforementioned problems. Accordingly, an object of the present invention is to provide a sound generating apparatus embedded into a shoe and its shoes, the sound generating apparatus having a sensor embedded into the shoe to generate sounds in a case where impacts or direction shifts are detected a certain number of times or more within a certain time, or in a case where impacts or direction shifts are detected a certain number of times at a time interval less than the certain time.

Another object of the present invention is to provide a sound generating apparatus embedded into a shoe and its shoes, the sound generating apparatus having a plurality of sensors embedded into the shoe to generate sounds of instruments different from each other or different sounds of identical instruments corresponding to each of the sensors if a motion signal is detected from the sensors so that a beat box or the like can be provided.

A further object of the present invention is to provide a sound generating apparatus embedded into a shoe and its shoes, the sound generating apparatus having a plurality of sensors embedded into the shoe to generate sounds of instruments different from each other or different sounds of identical instruments corresponding to combinations of the sensors if a motion signal is detected from the sensors so that a beat box or the like can be provided.

A still further object of the present invention is to provide a sound generating apparatus embedded into a shoe and its shoes, the sound generating apparatus having a plurality of sensors embedded into the shoe to repeatedly generate stored beat box sounds specified by each of the sensors or by combinations of the sensors once or several times if a motion signal is detected from the sensors.

A yet further object of the present invention is to provide a sound generating apparatus embedded into a shoe and its shoes, the sound generating apparatus having a motion recognition microchip embedded into the shoe to generate sounds corresponding to certain motions if the certain motions are detected.

According to an aspect of the present invention for achieving the object, there is provided a sound generating apparatus embedded into a shoe, comprising: a sensor embedded into the shoe to detect and output movements of the shoe; a microchip embedded into the shoe to output a sound if measured values are input a certain number of times from the sensor; a micro speaker embedded into the shoe to generate a sound output from the microchip; and a power supply embedded into the shoe to supply power to the sensor, the microchip and the micro speaker.

Further, according to another aspect of the present invention, there is provided a sound generating apparatus embedded into a shoe, comprising: a motion recognition microchip embedded into the shoe to detect and output movements of the shoe; a microchip embedded into the shoe to output a correspondent sound if the movements of the shoe are input from the motion recognition microchip; a micro speaker embedded into the shoe to generate a sound output from the microchip; and a power supply embedded into the shoe to supply power to the sensor, the microchip and the micro speaker.

Furthermore, according to a further aspect of the present invention, there is provided a sound generating apparatus embedded into a shoe, comprising: a plurality of sensors embedded into the shoe to detect and output movements of the shoe; a microchip embedded into the shoe to output a sound specified to the sensor if a measured values are input from the plurality of sensors; a micro speaker embedded into the shoe to generate a sound output from the microchip; and a power supply embedded into the shoe to supply power to the sensor, the microchip and the micro speaker.

### ADVANTAGEOUS EFFECTS

According to the present invention, since a sound is generated only in a case where movements of a shoe are detected certain number of times or more within a certain time, power consumption can be minimized, so that it can be used without replacing a battery for a long time.

Further, according to the present invention, since a variety of sounds can be generated, it is profitable to arouse user's interest.

### BRIEF DESCRIPTION OF THE DRAWINGS

The above and other objects, features and advantages of the present invention will become apparent from the following description of preferred embodiments given in conjunction with the accompanying drawings, in which:

FIG. 1 is a perspective view of a shoe into which a sound generating apparatus is embedded according to an embodiment of the present invention;

FIG. 2 is a block diagram showing an internal configuration of the sound generating apparatus embedded into the shoe according to the embodiment of the present invention;

FIG. 3 is a flow chart illustrating a method of controlling a sound generating apparatus embedded into a shoe according to a first preferred embodiment of the present invention;

FIGS. 4 to 6 are flowcharts illustrating processes of counting movements of a shoe existing within a certain time interval in FIG. 3;

FIGS. 7 to 9 are flowcharts illustrating the sound generating process of FIG. 3;

FIG. 10 is a block diagram showing an internal configuration of a sound generating apparatus embedded into a shoe according to a second preferred embodiment of the present invention;

FIG. 11 is a block diagram showing an internal configuration of a sound generating apparatus embedded into a shoe according to a third preferred embodiment of the present invention; and

FIG. 12 is a block diagram showing an internal configuration of a sound generating apparatus embedded into a shoe according to a fourth preferred embodiment of the present invention.

### BEST MODE FOR CARRYING OUT THE INVENTION

Hereinafter, a sound generating apparatus embedded into a shoe and its shoes according preferred embodiments of the present invention will be described in detail with reference to the accompanying drawings.

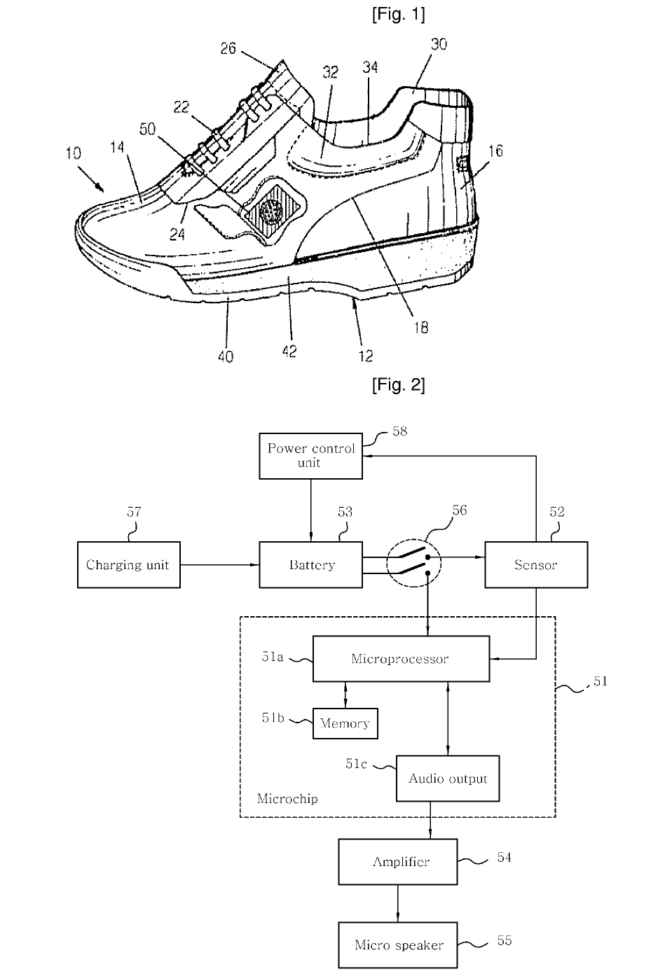

FIG. 1 is a perspective view of a shoe into which a sound generating apparatus is embedded according to an embodiment of the present invention.

Referring to this figure, the shoe into which a sound generating apparatus is embedded according to the embodiment of the present invention comprises an upper portion 10 and an outsole 12. The upper portion 10 has a vamp 14 attached to an upper foxing 16 with a stitching line (not shown) along a pattern line 18.

An eyelet cover 24 and a hole supporting cover 22 finished with a tongue 26 are provided to the vamp 14 of the upper portion 10.

Further, an inner layer 30 is also snitched to the upper portion 10 to extend around an internal surface of the vamp 14. The inner layer 30 is made of pig skin, cloth, other material or a combination thereof. A pad type collar 32 is provided around an upper edge portion 34 of an upper vertex so that a wear feeling of a wearer is increased. The outsole 12 comprises an upper sole 40 and a lower sole 42.

Further, a sound generating apparatus 50 is installed inside the vamp 14 of the upper portion 10 of the shoe and preferably positioned between the eyelet cover 24 and the outsole 12. It will be apparent that the sound generating apparatus 50 may be positioned inside the rear foxing 16 or at any place.

It is preferred that the sound generating apparatus 50 meet a waterproofing property by developing it as a module permanently embedded into the shoe. Further, it is preferred that the sound generating apparatus 50 satisfy a condition of 10M (waterproof). Furthermore, it is preferred that the sound generating apparatus 50 satisfy a protective property against an impact form the outside and bear a load of 60 kg.

In addition, since the shoe is mainly used outside, the sound generating apparatus 50 can preferably perform a normal operation at −10° C. to 40° C.

FIG. 2 is a block diagram showing an internal configuration of the sound generating apparatus embedded into the shoe according to the embodiment of the present invention.

Referring to this figure, the sound generating apparatus comprises a microchip 51, a sensor 52, a battery 53, an amplifier 54, a micro speaker 55, a switch 56, a charging unit 57 and a power control unit 58.

Here, the microchip 51 is preferably possible to use a P51VP chip which is a voice playback chip manufactured by Paion. The microchip 51 has a microprocessor 51a, a memory 51b and an audio output 51c built therein. Human voices (greetings, songs, numerals, a multiplication table and the likes), singing sounds of animals (e.g., singing sounds of cats, dogs, tigers, seals, goats cows, ducks and the likes), artificial synthesizing sounds (e.g., sounds of dinosaurs, sounds of space vacuums, and the likes), music files, beat box files, sounds of musical instruments or the likes are encoded in the memory 51a, its file format is not limited thereto but may preferably use a wave file format. In order to generate sounds, the microprocessor 51a reads randomly or sequentially human voices, singing sounds of animals, artificial synthesizing sounds, music files, beat box files, sounds of musical instruments or the likes stored in the memory 51b, and then output them to the audio output. Then, the audio output 51c decodes the human voices, singing sounds of animals, artificial synthesizing sounds, music files, beat box files, sounds of musical instruments or the likes received from the microprocessor 51a, and then output them.

Meanwhile, the sensor 52 may use an impact sensor, pressure sensor, vibration sensor, acceleration sensor with no analog/digital (A/D) converter, acceleration sensor with an A/D converter, geomagnetic sensor or the like. Here, in a case where a wearer land on the ground, the impact sensor detects and output the landing state, and the output signal is divided into On and OFF signals. Further, the vibration sensor, which is used in a step counter or the like, generates a signal when the positive and the negative are simply contacted with each other. The acceleration sensor measures and output an acceleration state of a user, and an analog signal is output therefrom. If an A/D converter is used together with the acceleration sensor, a digitalized value for measured acceleration can be obtained.

Here, in a case where an impact sensor and a vibration sensor are used as the sensor 52, the microprocessor 51a counts the number of generation times of ON signals. At this time, the microprocessor 51a performs counting only in a case where the time interval of the on signals is within a certain time so that it reads a sound stored in the memory 51b and output it to the audio output 51c if a certain number of times exceeds in counting. In this case, the microprocessor 51a resets counting and then performs re-counting if a certain number of times exceeds in counting.

Further, in a case where the sensor 52 is an acceleration sensor, the microprocessor 51a determines a signal of a certain value or more as an ON signal and a signal of a certain value or less as an OFF signal if an A/D converter is not provided. If the microprocessor 51a counts the number of times of ON signals input after the OFF signal (At this time, an input time of the OFF signal should be less than a predetermined time.), and it exceeds a certain number of times, the microprocessor 51a reads a sound stored in the memory 51b and then output it to the audio output 51c. In a case where an acceleration sensor provided with an A/D converter is used as the sensor 52, the microprocessor 51a may recognize a shift of a direction between positive (+) and negative (−) signals as one return. If the microprocessor 51a counts the number of times where returns are generated within a predetermined time (interval), and a certain number of times exceeds in counting, the microprocessor 51a reads a sound stored in the memory 51b and then output it to the audio output 51c.

As an example, in a case where an acceleration sensor is used as the sensor 52, if direction shifts of acceleration input from the sensor 52 are three times or more at a time interval within 0.1 second, the microprocessor 51a reads a sound stored in the memory 51b and then output it to the audio output 51c. Further, as another example, the microprocessor 51a may be realized such that it generates a sound in minimum 10 minutes after it has generated a sound once.

The amplifier 54 may be used as necessary, and amplifiers and then outputs sound data transmitted from the microchip 51.

The battery 53 supplies power to the microchip 51, the acceleration sensor 52, the amplifier 54 and the micro speaker 55. It will be apparent that only the battery 53 may be designed to be attachable or detachable, or such that the entire of the sound generating apparatus 50 can be attachable to or detachable from the shoe.

Further, the sound generating apparatus 50 has the switch 56 positioned between the battery and the microchip 51, the acceleration sensor 52, the amplifier 54 and the micro speaker 55. The sound generating apparatus 50 enables a user to manually turn it on/off using the switch 56 so that power consumption can be prevented. At this time, if the switch 56 is turned on, the microprocessor 51a reads a specified sound stored in the memory 51b to generate it according thereto. A sound providing fast feeling, a fantastic sound generated when a magical stick is swung, a voice of a manufacturer's name such as Nike, Adidas or the like may be used as the sound. By doing this, a manufacturer of shoes can advertise an image for its own company to customers.

In addition, the sound generating apparatus 50 has the power control unit 58 so that it may be realized such that a power source of the battery 53 is turned off in a few minutes if no movement of the shoe is detected from the sensor 52. It will be apparent that the sound generating apparatus 50 may enable the microprocessor 51a to implement a function of the power control unit 58 without the additional power control unit 58.

Further, the sound generating apparatus 50 has the charging unit 57 for charging the battery 53 and may use a contactless charging system for complete waterproof.

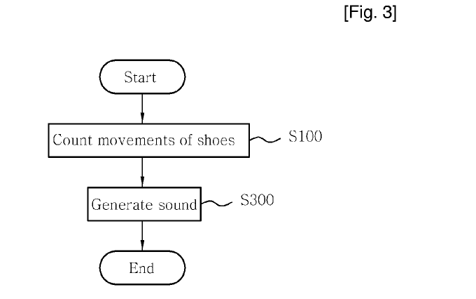

FIG. 3 is a flow chart illustrating a method of controlling a sound generating apparatus embedded into a shoe according to a preferred first embodiment of the present invention.

Referring to this figure, the method of controlling a sound generating apparatus embedded into a shoe according to the first preferred embodiment of the present invention comprises the steps of counting movements of the shoe (S100) and generating a sound (S300).

Here, the step of counting movements of the shoe is a process of counting whether or not there is a certain number of movements within a certain time after a microchip has received an ON/OFF signal, an analog acceleration signal or a digital acceleration signal from a sensor. At this time, the microchip resets counting and then performs re-counting if the microchip receives the next signal from the sensor after a certain time has elapsed. In addition, after the microchip generates a sound, it resets counting and then performs re-counting.

Further, the step of counting movements of the shoe may be a process of counting whether or not there is a certain number of consecutive movements at a time interval less than a certain time after the microchip has received an ON/OFF signal, an analog acceleration signal or a digital acceleration signal from the sensor. At this time, the microchip resets counting and then performs re-counting if the microchip receives the next signal from the sensor after a certain time has elapsed. In addition, after the microchip generates a sound, it resets counting and then performs re-counting.

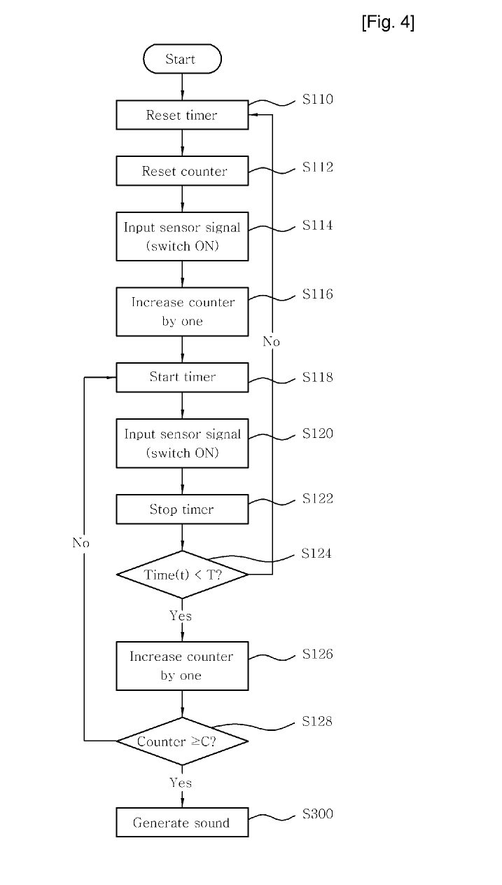

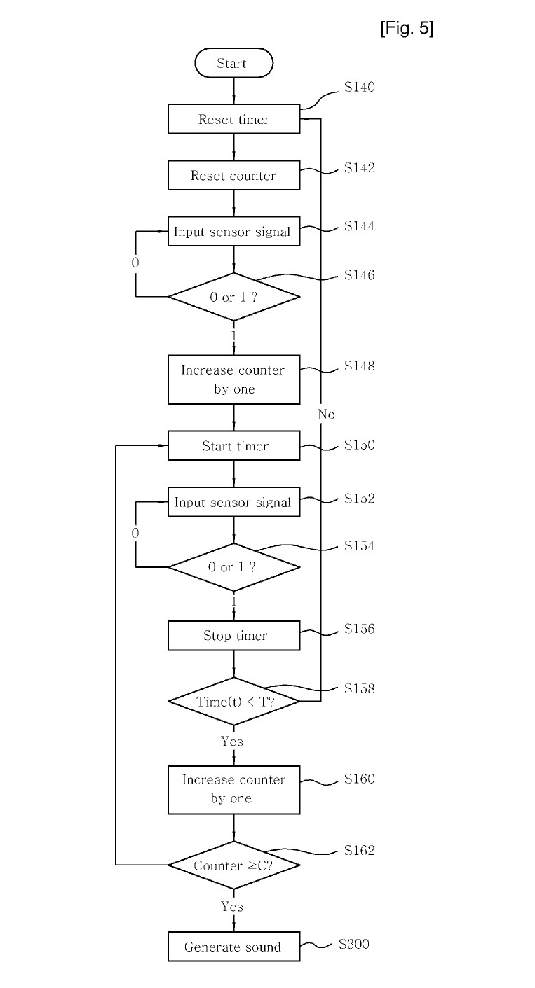

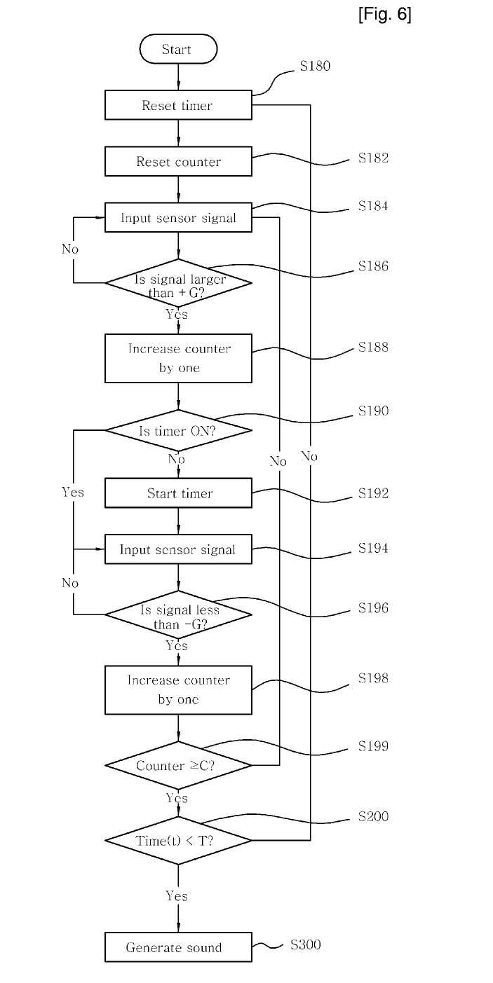

As for the step of counting movements of the shoe, FIG. 4 is a flowchart in a case of using an impact or mechanical sensor, FIG. 5 is a flowchart in a case of using an acceleration sensor with no A/D converter, and FIG. 6 is a flowchart in a case of using an acceleration sensor provided with an A/D converter.

Referring to FIG. 4, the microchip resets a timer (S110) and resets a counter (S112) so that it performs initiation in the step of counting movement of the shoe using the impact or the mechanical sensor.

Thereafter, if the microchip receives a switch ON signal from the sensor (S114), it increases the counter by one (S116) and then drives the timer (S118) so that the microchip can determine whether or not the next signal is input within a certain time interval.

Next, if the microchip receives a switch ON signal from the sensor (S120), it stops the timer (S122) and then determines whether or not the time is less than a certain time (S124). The microchip stops the counter (S126) if the time is less than the certain time, and it repeatedly performs a process from that of resetting the timer if the time is larger than the certain time. Further, the microchip repeatedly performs a process from that of starting the timer if the counted value is less than a certain value, and it generates a sound (S300) if the counted value is larger than the certain value, then it repeatedly performs a process from that of resetting the timer.

Referring to FIG. 5, the microchip resets a timer (S140) and resets a counter (S142) so that it performs initiation in the step of counting movement of the shoe using the acceleration sensor with no A/D converter.

Thereafter, if a signal is input from the sensor (S144), the microchip determines whether or not the signal is larger than a certain value so that it determines the signal as 0 if the signal is less than the certain value, and it determines the signal as 1 if the signal is larger than the certain value (S146). If the signal is 0, the microchip waits for a signal input from the sensor, and if the signal is 1, it increases the timer (S148). Then, the microchip drives the timer (S150) so that it can determine whether or not the next signal is input within a certain time interval.

Next, if a signal is input from the sensor (S152), the microchip determines whether or not the signal is larger than a certain value so that it determines the signal as 0 if the signal is less than the certain value, and it determines the signal as 1 if the signal is larger than the certain value (S154). If the signal is 0, the microchip waits for a signal input from the sensor, and if the signal is 1, it stops the timer (S156) so that it determines whether or not the time of the timer is less than a certain time (S158).

As the determined result, if the time of the timer is larger than the certain time, the microchip repeatedly performs a process from that of resetting the timer, and if the time of the timer is less than the certain time, it increases the counter by one (S160). Thereafter, if the counted value is less than a certain value, the microchip repeatedly performs a process from that of starting the timer, and if the counted value is less than the certain value, it generates a sound (S300).

Referring to FIG. 6, the microchip resets a timer (S180) and resets a counter (S182) so that it performs initiation in the step of counting movement of the shoe using the acceleration sensor provided with an A/D converter.

Thereafter, if a signal is input from the sensor (S184), the microchip determines whether or not the signal is larger than a certain positive value so that if the signal is less than the certain positive value, it waits for a signal input from the sensor to receive a signal, and if the signal is larger than the certain positive value, it increase the counter by one (S188), then it determines whether or not the timer is an ON state (S190).

As the determined result, if the timer is an OFF state, after the microchip drives the timer (S192) and determines whether or not returns are achieved a certain number of times within a certain time, it receives a signal from the sensor (S194). If the timer is an ON state, the microchip receives a signal from the sensor without a process of starting timer (S194)

Next, the microchip determines whether or not the signal input from the sensor is less than a certain negative value (S196) so that if the signal is less than the certain negative value, it waits a signal input from the sensor to receive a signal, and if the signal is larger than the certain negative value, it increase the counter by one, then determines whether or not the counted value is larger than a certain value (S199).

As the determined result, if the counted value is less than the certain value, the microchip repeatedly performs a process from that of waiting for a signal input from the sensor at the step S184, and if the counted value is larger than the certain value, it determines whether or not the time of the timer is less than a certain time (S200)

As the determined result, if the time of the timer is larger than the certain time, the microchip repeatedly performs a process from that of resetting the timer, and if the time of the timer is less that the certain time, it performs a process of generating a sound (S300)

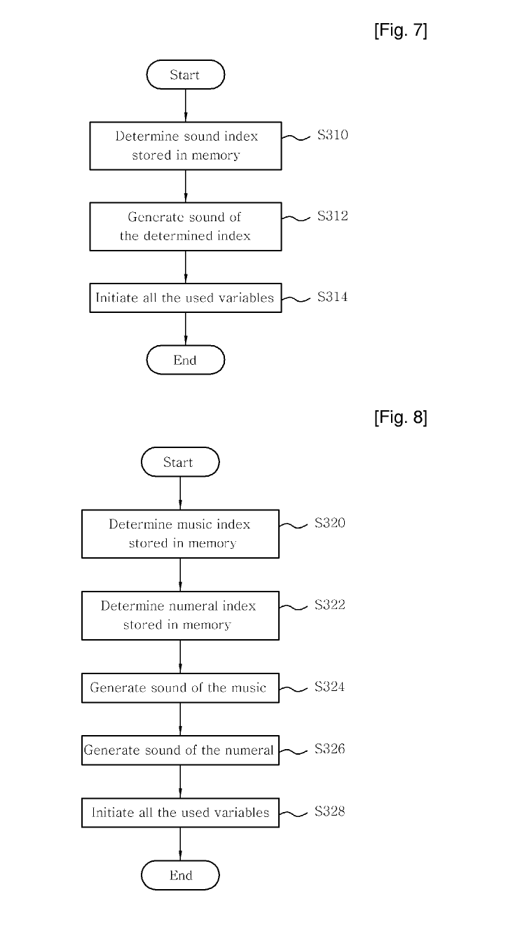

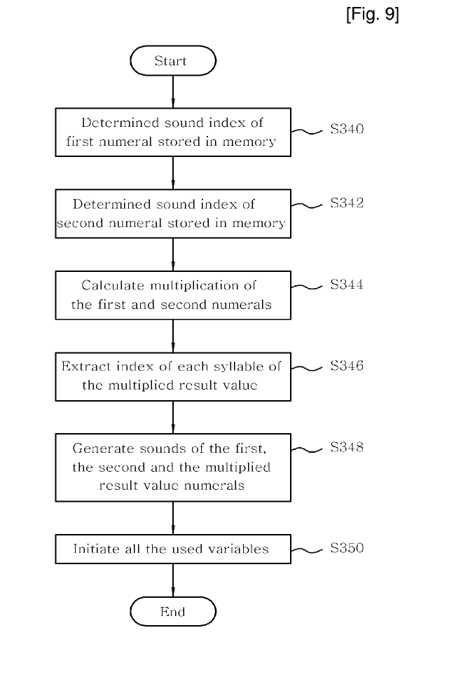

As for the step of generating a sound, FIG. 7 is a flowchart showing a process of generating a simple sound, FIG. 8 is a flowchart showing a process of generating a sound in a numeral game, and FIG. 9 is a flowchart showing a process of generating a sound in a multiplication table.

Referring to FIG. 7, the microchip determines a sound index stored in the memory (S310) and outputs a sound of the determined index to a micro speaker (S312), then initiates all the used variables (S314) in the process of generating a simple sound.

Referring to FIG. 8, the microchip determines a music sound index stored in the memory (S320) and a numeral sound index stored in the memory (S322) in the process of generating a sound in a numeral game.

Thereafter, the microchip outputs music of the music sound index to a micro speaker to generate a sound (S324) and a sound of the numeral sound index to the micro speaker to generate a sound (S326).

Next, the microchip initiates all the used variables (S328).

Referring to FIG. 9, the microchip determines a sound index of a first numeral stored in the memory (S340) and a sound index of a second numeral stored in the memory (S342), then multiplies the first numeral and the second numeral (S344) so that it extracts an index of the multiplied result value (S346) in the process of generating a sound in a multiplication table.

Thereafter, the microchip sequentially outputs sounds of the first, the second and the multiplied value numerals to a micro speaker to generate a sound (S348), and then initiates all the used variables (S350).

### MODE FOR THE INVENTION

Meanwhile, a variety of applications are possible except the methods illustrated above. Since it is possible not only that music or the like is simply reproduced but also that data divided into two groups or more are randomly accessed using a microprocessor, a function of a game or education may be added except that of simply listening to music.

For example, in a case where children's favorite music is divided into one with amount of about 6 to 10 seconds and then recorded to input to a group A (data), and a multiplication table is input to a group B, the children's favorite music is randomly played and the multiplication is then followed so that a function of education in which pupils with a superior learning ability at a kindergarten or elementary school (first to third grades) can easily learn the multiplication table may be added. Further, in a case where data are divided into three groups, ranks are input to a C group so that children can play with picture cards.

Although it is difficult to describe precise contents in detail, it is possible to record contents to be learned, such Korean, history, geography or the like. For example, contents in that Japanese invasion of Korea broke out in 1592, and the like are recorded so that the simple contents of history, geography or the like can be easily learned.

In addition thereto, voices of children's favorite stars (NBA, Major League and the like) are recorded so that they may talk to children with ordinary conversations. For example, they may say a greeting such as “How are you, my friend?”, and good messages are recorded so that they may make children feel so good. Good messages may be recorded in English.

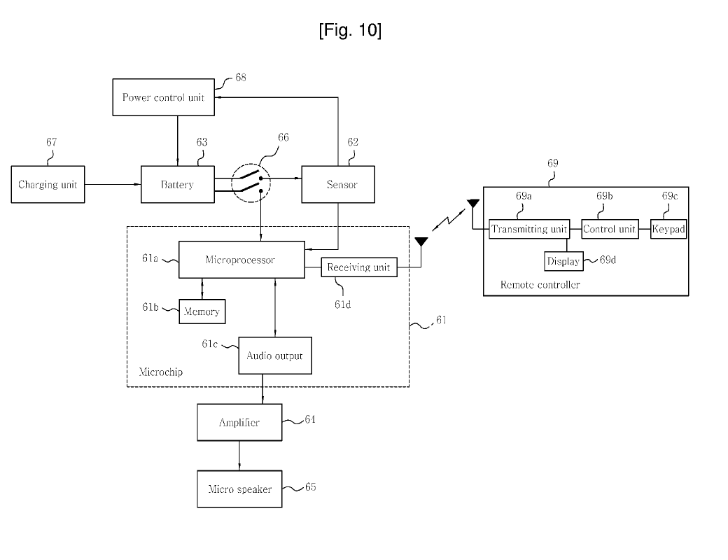

FIG. 10 is a block diagram showing an internal configuration of a sound generating apparatus embedded into the a shoe according to a second preferred embodiment of the present invention.

Referring to this figure, the sound generating apparatus according to the second preferred embodiment of the present invention comprises a microchip 61, a sensor 62, a battery 63, an amplifier 64, a micro speaker 65, a switch 66, a charging unit 67, a power control unit 68 and a remote controller 69.

Here, the microchip 61 further includes a receiving unit 61d contrary to the first embodiment, and the receiving unit 61d receives a sound selection signal transmitted from the remote controller 69 to transmit it to a microprocessor 61a.

The remote controller 69 comprises a transmitting unit 69a, a control unit 69b, a keypad 69c and display 69d. A user can select a desired sound (e.g., any one of a simple sound, numeral sound and sound in a multiplication table) using the keypad 69c, and the control unit 69b transmits a sound selection signal for the selected sound to the microprocessor 61a through the receiving unit 69a.

Then, the microprocessor 61a reads a correspondent sound stored in a memory 61b and transmits it to the micro speaker 65 through an audio output 61c to generate a sound.

In the second embodiment of the present invention, operations of the other components are identical to the first embodiment, and their detailed descriptions will be omitted.

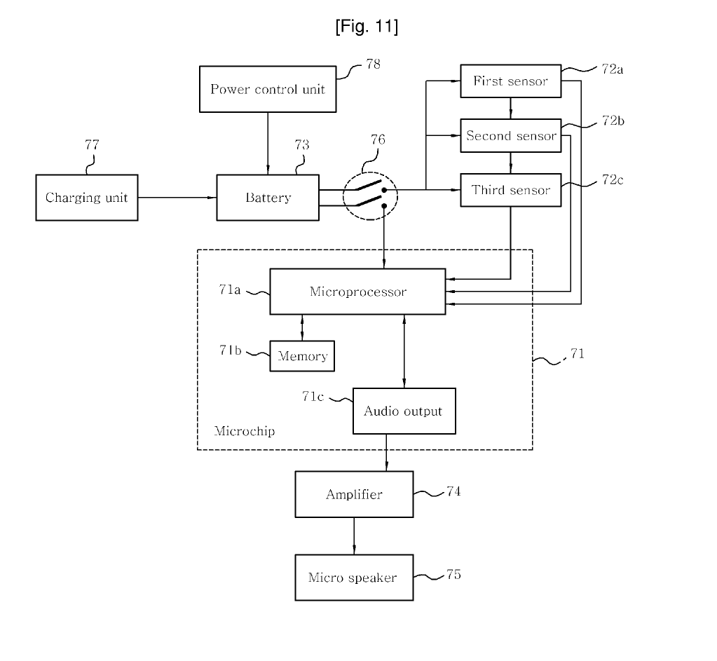

FIG. 11 is a block diagram showing an internal configuration of a sound generating apparatus embedded into a shoe according to a third preferred embodiment of the present invention.

Referring to this figure, the sound generating apparatus according to the third preferred embodiment of the present invention comprises a microchip 71, a plurality of sensors 72a to 72c, a battery 73, an amplifier 74, a micro speaker 75, a switch 76, a charging unit 77 and a power control unit 78.

As such, the third embodiment are different from the first and second embodiments in that the sound generating apparatus embedded into a shoe has the plurality of sensors 72a to 72c, and realization of a beat box is possible due to the plurality of sensors 72a to 72c.

As an example, an impact sensor is used as a first sensor 72a as and embedded into a front portion of a shoe; an impact sensor is used as a second sensor 72b and embedded into a rear portion of the shoe; and an acceleration sensor is used as a third sensor 72c and embedded into a center portion of the shoe. Then, if a detection signal is input from the first sensor 72a, the microprocessor 71a generates a K (kick) of K (kick), S (Snare) and H (Hihat), which are three factors of a drum in a beat box; if a detection signal is input from the second sensor 72b, it generates an H (Hihat) of the three factors; and if a detection signal is input from the third sensor 72c, it generates an S (Snare) of the three factors. Here, the reason why the third sensor 72c uses the acceleration sensor is that it can detect a signal when a wearer acts a motion of kicking forward. Further, the reason why the microprocessor 71a generates an S (Snare) if a detection signal is input from the third sensor 72c is that it generates the S (Snare), of which frequency is the lowest, because the motion of kicking forward is more difficult than that of applying an impact.

As such, the microprocessor 71a is realized to respectively generate the factors of the drum different from one another in accordance with locations of the sensors 72a to 72c so that the wearer can realize the beat box by moving own shoes in a desired direction.

Although the plurality of sensors 72a to 72c are connected with the three factors of the drum in this case, it will be apparent that they may be connected with other musical instruments. That is, the first to third sensors 72a to 72c may be connected to a drum, a timpani and a xylophone.

In addition, although the plurality of sensors 72a to 72c are the same musical instrument in this case, the microprocessor 71a may be realized to generate a different tone (e.g., do, re, mi, . . . ).

Moreover, sounds of musical instruments different from one another or different sounds of the same musical instrument may be respectively specified to various combinations of the plurality of sensors 72a to 72c (e.g., the first and second sensors to a drum, the first and third sensors to a timpani, the second and third to a xylophone, and the like) so as to generate a sound.

Further, numbers are allocated to the various combinations of the plurality of sensors 72a to 72c (e.g., the first sensor (impact sensor) and the second sensor (acceleration sensor) to 1, the first sensor and the third sensor (impact sensor) to 2, and the second and third sensors to random) so that a music or beat box file stored as the allocated number can be read and then generated.

In the third embodiment of the present invention, operations of the other components are identical to the first embodiment, and their detailed descriptions will be omitted.

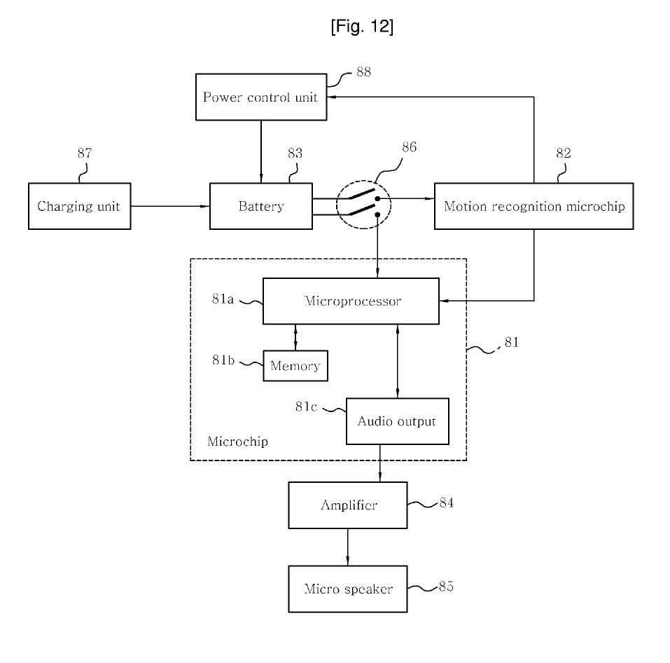

FIG. 12 is a block diagram showing an internal configuration of a sound generating apparatus embedded into a shoe according to a fourth preferred embodiment of the present invention.

Referring to this figure, the sound generating apparatus according to the fourth preferred embodiment of the present invention comprises a microchip 81, a motion recognition microchip 82, a battery 83, an amplifier 84, a micro speaker 85, a switch 86, a charging unit 87 and a power control unit 88.

As such, the fourth embodiment is different from the first to third embodiments in that the sound generating apparatus has the motion recognition microchip 82, and a variety of sounds can be generated depending on a user s operation due to the motion recognition microchip.

As an example, in a case where a wearer of the shoes takes a motion of an alphabet, the motion recognition microchip 82 recognizes the motion of the alphabet, and a microprocessor 81a reads a sound of the alphabet from a memory 81b to generate a sound according thereto.

In addition, in a case where a wearer of the shoes takes a motion of an alphabet, the motion recognition microchip 82 recognizes the motion of the alphabet, and a microprocessor 81a reads a sound of a musical instrument specified to each of the alphabets from the memory 81b to generate a sound according thereto.

Moreover, in a case where a wearer of the shoes takes a motion of an alphabet, the motion recognition microchip 82 recognizes the motion of the alphabet, and a microprocessor 81a reads a sound of a correspond factor in the three factors of a beat box of a drum, which is specified to each of the alphabets, from the memory 81b to generate a sound according thereto.

In the fourth embodiment of the present, operations of the other components are identical to the first embodiment, and their detailed descriptions will be omitted.

Meanwhile, although a case of generating a sound once has been described in the embodiments of the present invention, it can be realized to repeatedly generate the same sound a certain number of times. It will be apparent that it can be realized to stop the repeated generation of the sound automatically after a certain time, or by means of a control of an external remote controller or a passive switch.

In addition, although a shoe has been described in the embodiments of the present invention, in a case where a sound generating apparatus is embedded into a pair of shoes, the same sound generating apparatus provided with the same function are embedded into the shoes, or sound generating apparatus for playing music files and beat boxes are respectively embedded into the one shoe and the other shoe so that a variety of sounds can be played. That is, sound generating apparatus can be embedded into both the shoes by means of various combinations of the embodiments described above.

Although the present invention has been described in detail in connection with the preferred embodiment, it will be readily understood by those skilled in the art that various modifications and changes can be made thereto within the technical spirit and scope of the present invention. It is also apparent that the modifications and changes fall within the scope of the present invention defined by the appended claims.

1. A sound generating apparatus embedded into a shoe, comprising:
a sensor embedded into the shoe to detect and output movements of the shoe;
a microchip embedded into the shoe to output a sound when measured values are input a certain number of times from the sensor;
a micro speaker embedded into the shoe to generate a sound output from the microchip; and
a power supply embedded into the shoe to supply power to the sensor, the microchip and the micro speaker.

2. The sound generating apparatus as claimed in claim 1, wherein the sensor is any one of impact, pressure, vibration, acceleration and geomagnetic sensors.

3. The sound generating apparatus as claimed in claim 1, wherein the microchip outputs a sound when consecutive measured values are input a certain number of times from the sensor at a time interval less than a certain time.

4. The sound generating apparatus as claimed in claim 1, wherein the microchip outputs a sound when measured values are input a certain number of times from the sensor within a certain time.

5. The sound generating apparatus as claimed in claim 1, wherein the sound output from the microchip is at least one of simple, multiplication table, education contents, conversation, game, instrument, music and beat box sounds.

6. The sound generating apparatus as claimed in claim 1, further comprising
a receiving unit embedded into the shoe to receive a control signal by wireless and then provide it to the microchip; and
a remote controller for transmitting a control signal to the receiving unit by wireless.

7. The sound generating apparatus as claimed in claim 1, further comprising a switch embedded into the shoe to turn on/off the power supply of a battery.

8. The sound generating apparatus as claimed in claim 7, wherein the microchip reads a start sound from a memory and then output it to the micro speaker when the switch is turned on.

9. The sound generating apparatus as claimed in claim 1, further comprising a charging unit embedded into the shoe to charge a battery of the power supply.

10. The sound generating apparatus as claimed in claim 1, further comprising a power control unit embedded into the shoe to turn off the power supply when a signal is not detected from the sensor for a certain time.

11. The sound generating apparatus as claimed in claim 1, wherein the microchip turns off the power supply when a signal is not detected from the sensor for a certain time.

12. A sound generating apparatus embedded into a shoe, comprising:
a motion recognition microchip embedded into the shoe to detect and output movements of the shoe;
a microchip embedded into the shoe to output a correspondent sound when the movements of the shoe are input from the motion recognition microchip;
a micro speaker embedded into the shoe to generate a sound output from the microchip; and
a power supply embedded into the shoe to supply power to the sensor, the microchip and the micro speaker.

13. The sound generating apparatus as claimed in claim 12, wherein the motion recognition microchip and the microchip are integrated.

14. The sound generating apparatus as claimed in claim 12, wherein the sound output from the microchip is at least one of simple, multiplication table, education contents, conversation, game, instrument, music and beat box sounds.

15. A sound generating apparatus embedded into a shoe, comprising:
a plurality of sensors embedded into the shoe to detect and output movements of the shoe;
a microchip embedded into the shoe to output a sound specified to the sensor when a measured values are input from the plurality of sensors;
a micro speaker embedded into the shoe to generate a sound output from the microchip; and
a power supply embedded into the shoe to supply power to the sensor, the microchip and the micro speaker.

16. The sound generating apparatus as claimed in claim 15, wherein the sensor is any one of impact, pressure, vibration, acceleration and geomagnetic sensors.

17. The sound generating apparatus as claimed in claim 15, wherein the sounds generated by the microchip are sounds of musical instruments different from one another specified to the plurality of sensors, respectively.

18. The sound generating apparatus as claimed in claim 15, wherein the sounds generated by the microchip are different sounds of a musical instrument, which are specified to the plurality of sensors, respectively.

19. The sound generating apparatus as claimed in claim 15, wherein the sounds generated by the microchip are music files, beat box files or the likes specified depending on a combination of the plurality of sensors.

20. The sound generating apparatus as claimed in claim 15, wherein the sounds generated by the microchip are different sounds of a drum specified to the plurality of sensors, respectively, and
wherein a wearer of shoes moves the shoes to play a beat box.

21. Shoes into which a sound generating apparatus embedded, the sound generating apparatus comprising:
a sensor embedded into the shoe to detect and output movements of the shoe;
a microchip embedded into the shoe to output a sound when measured values are input a certain number of times from the sensor;
a micro speaker embedded into the shoe to generate a sound output from the microchip; and
a power supply embedded into the shoe to supply power to the sensor, the microchip and the micro speaker.

22. The shoes as claimed in claim 21, wherein the microchip outputs a sound if consecutive measured values are input a certain number of times from the sensor at a time interval less than a certain time.

23. The shoes as claimed in claim 21, wherein the microchip outputs a sound if measured values are input a certain number of times from the sensor within a certain time.

24. The shoes as claimed in claim 21, wherein the sound output from the microchip is at least one of simple, multiplication table, education contents, conversation, game, instrument, music and beat box sounds.

25. The shoes as claimed in claim 21, further comprising:
a receiving unit embedded into the shoe to receive a control signal by wireless and then provide it to the microchip; and
a remote controller for transmitting a control signal to the receiving unit by wireless.

26. The shoes as claimed in claim 21, further comprising a charging unit embedded into the shoe to charge a battery of the power supply.

27. The shoes as claimed in claim 21, further comprising a power control unit embedded into the shoe to turn off the power supply when a signal is not detected from the sensor for a certain time.

28. The shoes as claimed in claim 21, wherein the microchip turns off the power supply when a signal is not detected from the sensor for a certain time.

29. Shoes into which a sound generating apparatus embedded, the sound generating apparatus comprising:
a motion recognition microchip embedded into the shoe to detect and output movements of the shoe;
a microchip embedded into the shoe to output a correspondent sound if the movements of the shoe are input from the motion recognition microchip;
a micro speaker embedded into the shoe to generate a sound output from the microchip; and
a power supply embedded into the shoe to supply power to the sensor, the microchip and the micro speaker.

30. Shoes into which a sound generating apparatus embedded, the sound generating apparatus comprising:
a plurality of sensors embedded into the shoe to detect and output movements of the shoe;
a microchip embedded into the shoe to output a sound specified to the sensor when a measured values are input from the plurality of sensors;
a micro speaker embedded into the shoe to generate a sound output from the microchip; and
a power supply embedded into the shoe to supply power to the sensor, the microchip and the micro speaker.

31. The shoes as claimed in claim 30, wherein the sounds generated by the microchip are music files, beat box files or the likes specified depending on a combination of the plurality of sensors.

32. The shoes as claimed in claim 30, wherein the sounds generated by the microchip are different sounds of a drum specified to the plurality of sensors, respectively, and
wherein a wearer of shoes moves the shoes to play a beat box.
